(19) United States
(12) Patent Application Publication
(10) Pub. No.: US 2026/0213430 A1
(43) Pub. Date: Jul. 23, 2026

(54) OPTICAL TRAVELLING-WAVE ANTENNA FOR CIRCULARLY POLARIZED BROADSIDE EMISSION

(71) Applicant: Dell Products L.P., Round Rock, TX (US)

(72) Inventors: Tejinder Singh, San Jose, CA (US); Navjot Kaur Khaira, San Jose, CA (US); Morris Repeta, Ottawa (CA); Keigan Macdonell, Ottawa (CA); Shulabh Gupta, Ottawa (CA)

(21) Appl. No.: 19/272,340

(22) Filed: Jul. 17, 2025

Related U.S. Application Data
(60) Provisional application No. 63/747,215, filed on Jan. 20, 2025.

(51) Int. Cl. H01Q 21/06; H01Q 11/02; H01Q 15/02

(52) U.S. Cl. CPC H01Q 21/068; H01Q 11/02; H01Q 15/02

(57) ABSTRACT

The technology described herein is generally directed towards an optical grating antenna designed as a travelling wave or leaky wave antenna, based on laterally asymmetrical and rotated structural perturbations along the antenna. In one implementation, the perturbations are protrusions in the form of nanopillar pairs distributed along the top (wire) of the antenna. The lateral asymmetry and opposite rotations of each pairs'perturbations, relative to each other and to the wire in the segment pairs'distribution, produces strong emissions with rotated polarity in the broadside direction, unlike conventional grating antennas that have a stopband at broadside emission. The optical antenna, which can be implemented as a silicon-on-insulator waveguide, is suitable for rotated polarity in emissions from the antenna, which can be tunable polarization based on rotation-related design parameters. Instead of nanopillar pairs, other implementations can have structural perturbations of different geometries, including different shapes and/or cavities in the antenna structure.

### RELATED APPLICATION

The subject patent application claims priority to U.S. Provisional Patent Application Ser. No. 63/747,215, filed Jan. 20, 2025, and entitled “OPTICAL TRAVELLING-WAVE ANTENNA FOR CIRCULARLY POLARIZED BROADSIDE EMISSION” (docket no. 141982.01/DELLP1498US), the entirety of which priority patent application is hereby incorporated by reference herein.

### BACKGROUND

A grating antenna is a type of travelling wave antenna that couples a guided mode to a radiating mode via physical perturbations in the waveguiding structure. Grating antennas are used for coupling optical surface waves to free space or optical fibers. Across the length of the antenna, a guided wave is progressively ‘leaked’ into the coupled mode through perturbations in the guiding structure.

### BRIEF DESCRIPTION OF THE DRAWINGS

The technology described herein is illustrated by way of example and not limited in the accompanying figures in which like reference numerals indicate similar elements and in which:

FIG. 1 is a top-view representation of an example grating antenna model including laterally asymmetrical pairs of rotated nanopillars, and showing some example design dimensions, in accordance with various example embodiments and implementations of the subject disclosure.

FIG. 2 is a zoomed-in, rotated representation of a portion of FIG. 1 showing various other example design dimensions of nanopillar pairs, in accordance with various example embodiments and implementations of the subject disclosure.

FIG. 3 is a three-dimensional representation of the example grating antenna model of FIG. 1 showing various other example design dimensions, in accordance with various example embodiments and implementations of the subject disclosure.

FIG. 4 is a graphical representation showing example reflected magnitude at an input port of an example grating antenna, configured with asymmetrical perturbations, versus frequency for various pillar rotations, in accordance with various example embodiments and implementations of the subject disclosure.

FIG. 5 is a graphical representation showing example reflection and transmission S-parameters versus frequency for a grating antenna configured with generally optimal rotated nanopillars, in accordance with various example embodiments and implementations of the subject disclosure.

FIGS. 6 and 7 are graphical representations of example gain plots for an example travelling wave antenna as described herein at 193.55 THz, for the orthogonal phi and theta components, respectively, in accordance with various example embodiments and implementations of the subject disclosure.

FIG. 8 is a graphical representation of the example axial ratio versus beam-angle near broadside for an example travelling wave antenna as described herein at an operating frequency of 193.55 THz, showing a trend towards circular polarity (0 dB) as the pillars are more fully rotated, in accordance with various example embodiments and implementations of the subject disclosure.

FIG. 9 is a representation of an example (divided) grating antenna structure designed with rotated cuboid nanopillars, in accordance with various example embodiments and implementations of the subject disclosure.

FIG. 10 is a representation of an example (divided) grating antenna structure designed with rotated cuboid trenches, in accordance with various example embodiments and implementations of the subject disclosure.

### DETAILED DESCRIPTION

The technology described herein is generally directed towards an optical travelling wave antenna / grating antenna that achieves high broadside gain, such as for use in applications involving light detection and ranging (LIDAR), wireless communications, and reconfigurable and holographic displays. The grating antenna design described herein achieves circularly polarized emissions through a rotation of the perturbations, which can be configured as groups (e.g., pairs) of nanopillars or trenches distributed along the waveguide length of the optical travelling antenna. One implementation of this design operates as an optical antenna source with precise control over the direction and polarization of its emissions.

Conventional grating antennas experience a decrease in realized gain as the operational frequency shifts towards a guided wavelength that is equal to the period of the perturbation. Indeed, in conventional traveling wave antennas a sharp reduction in matching (high reflection of the input energy occurs) across a frequency band that produces broadside emissions; this reduction in efficiency through this frequency range is referred to as a stopband problem. Overcoming this limitation can maintain uniform gain across a given frequency band.

In contrast to conventional grating antennas, described herein is generally directed towards an optical travelling wave antenna that achieves high broadside gain and overcomes the stopband problem, including by having lateral asymmetry in the perturbations. The optical travelling wave antenna with asymmetrical perturbations as described herein maintains substantially uniform gain across a given frequency range and ensures maximal or virtually maximal emission at a normal angle to the substrate. The direction of the emissions depends on the periodicity of the perturbations and the frequency of operation.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in optical antennas in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

As will be understood, described herein is a grating antenna that can be constructed through nanofabrication techniques, such as realized as silicon-on-insulator (SOI) devices. As one example usage, by clustering multiple grating antennas as described herein into an array with independently tuned phase, amplitude, and directivity, a reconfigurable, holographic display can be produced.

Several design variants of the grating antenna are described herein, each of which overcomes the well-known broadside, bandstop issue through an incorporation of asymmetrical perturbations. The offsets of the perturbations are optimal, due to the phase relation of the reflected waves between the perturbations experiencing destructive interference.

These variants tailor their emissions based on directivity and polarity, and demonstrate the ability to maximize broadside gain in an optical grating antenna. The design variants have been successfully demonstrated in simulations, and have dimensions that can be fabricated through e-beam lithography.

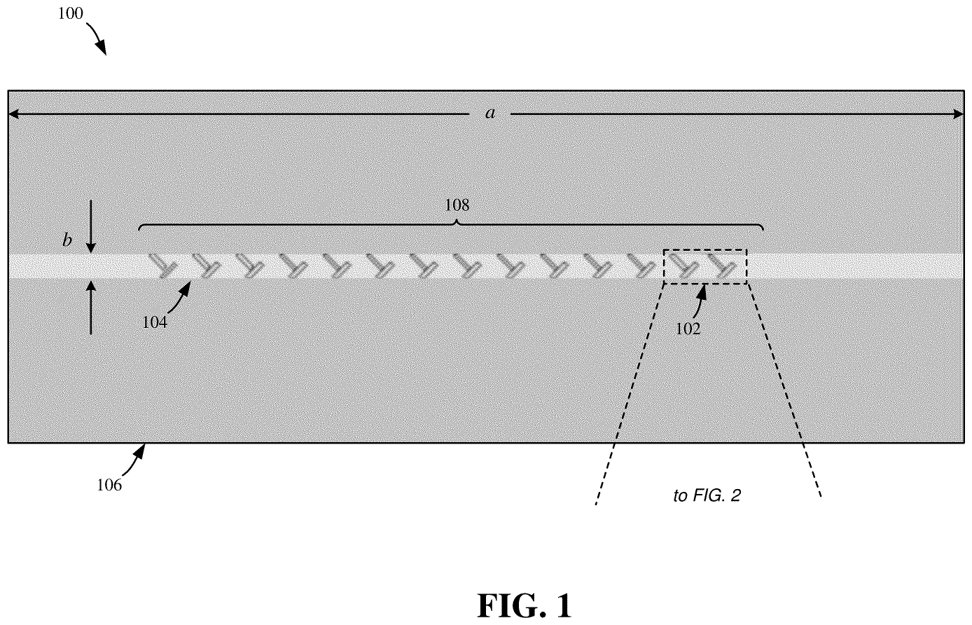

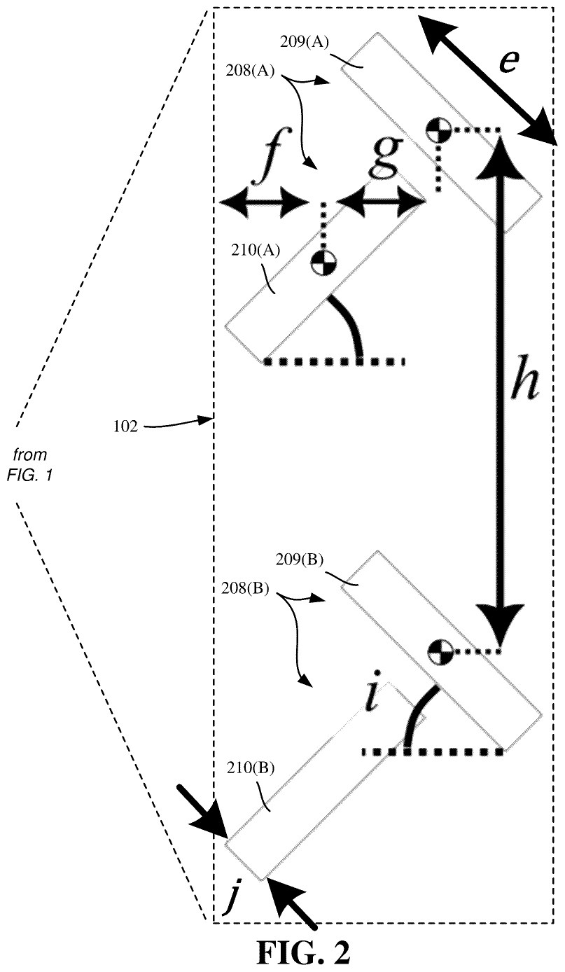

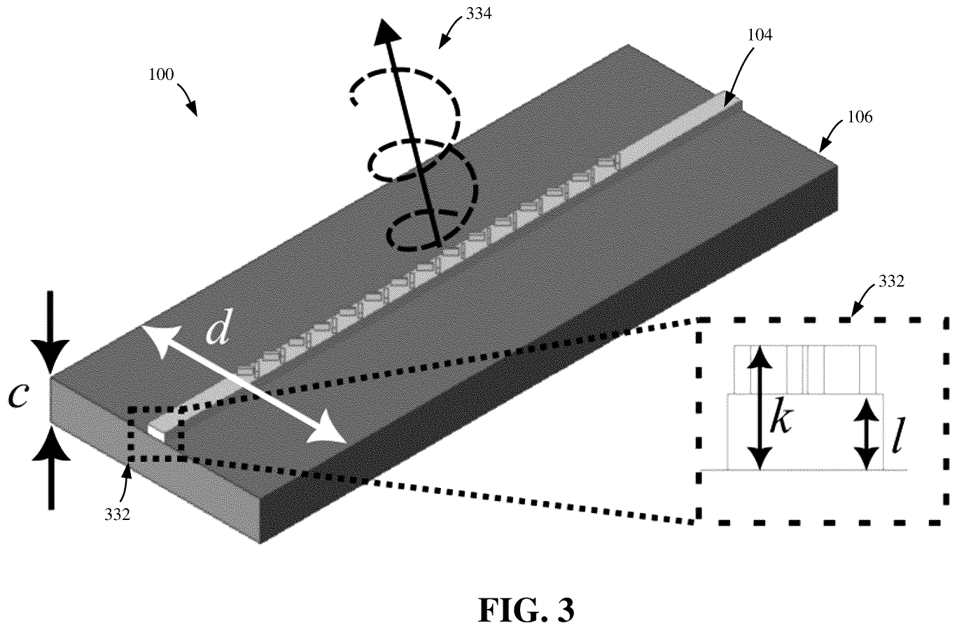

A dimensioned model for an optical grating antenna structure 100 designed for circularly polarized broadside emission is presented in FIG. 1, with a zoomed-in (and rotated) portion thereof shown 102 in FIG. 2. FIG. 3 is a three-dimensional (3D) representation of the grating antenna structure 100 (or a substantially similar model) including the (e.g., silicon) wire 104 on the (e.g., silicon dioxide) substrate 106. FIG. 3 also shows a conceptual representation 334 of the circularly polarized broadside emission from the structure 100.

In this example structure 100, FIGS. 1 and 2 show a simulated grating antenna model, that is, one which can be simulated in Ansys FEM-HFSS. A silicon wire waveguide (light gray) 104 constructed on silicon dioxide (dark gray) 106 is sized to support a single guided transverse electric (TE) mode. Perturbations in the form of pairs of distributed nanopillars (collectively labeled 108), shown as rotated “separated perpendicular shaped” pairs of nanopillars, are fabricated across a portion of the length of the silicon wire waveguide; in this example, the individual pairings of nanopillars are oriented diagonally (e.g., each pair including a −45° rotated nanopillar and +45° rotated nanopillar) relative to the length of the wire 104.

FIG. 2 shows two of the pairs of nanopillars 208(A) and 208(B). In this example each of the pairs include separate protrusions in the form of nanopillars that are angled perpendicularly or substantially perpendicularly to one another, and angled diagonally (e.g., −45° and +45°) relative to the silicon wire waveguide 102. Thus, the nanopillar pair 208(A) includes two separate nanopillars 209(A) and 210(A), and the nanopillar pair 208(B) includes two separate nanopillars 209(B) and 210(B).

In FIG. 1, the length of the optical grating antenna structure 100 is represented by dimension label a, and the width of the silicon wire waveguide 104 is represented by dimension label b. In FIG. 3, the height of the silicon dioxide substrate 106 is represented by dimension label c, and the width of the silicon dioxide substrate 106 is represented by dimension label d. In FIG. 2, the zoomed-in portion 102 of the structure 100 includes labels e-j for various design dimensions. In FIG. 3, the zoomed-in portion 332 includes labels k and l representing the total height k of the silicon wire waveguide 104 plus the height of the nanopillar perturbations, and the height l of the silicon wire waveguide 104 without the nanopillar perturbations, respectively.

In the example of FIGS. 1-3 , the pillars in each pair are rotated the same angle i (relative to the silicon wire waveguide 104), in opposite directions, in order to produce the rotated polarity in the emission. As is understood, any of the height, width and length dimensions, as well as the angles of each of the nanopillars relative to one another and/or relative to the silicon wire waveguide 102, can be varied for a given design implementation. For example, in one implementation, the structure 100 includes a 450 nm (nanometers) by 220 nm silicon wire 102 on silicon dioxide 104. The dimensions shown in FIGS. 1-3 , including the dimensions of the laterally asymmetrical nanopillars, are a=15 μm, b=450 nm, c=1 μm (micron), d=5450 nm, e=300 nm, f=150 nm, g=150 nm, h=, j=67 nm, 670 nm, i=45°, k=360 nm, l=220 nm. In an alternative implementation, the dimensions can be a=670 nm, b=300 nm, c=170 nm, d=140 nm, ∧e=70 nm, with the other dimensions f−l modifiable as appropriate for a given design. It is noted that the actual length of this kind of antenna can be increased towards the millimeter scale, as the reduced-size model is designed and simulated for convenience.

Thus, one implementation of the antenna uses a silicon wire for a waveguide, with the perturbations introduced as rectangular nanopillars on top. The nanopillars occur in pairs, which are offset laterally to introduce asymmetry, and separated by λ_{g}/4 in order to cancel reflections and improve matching. The pairs are separated by λ_{g} for a free space operational wavelength of 1.55 μm (194 THz), in order to produce broadside emissions (e.g., θ=0°), e.g., shown in the representation 334 of FIG. 3. The length of the antenna can be reduced to improve simulation time and can be increased to improve the realized gain in application implementations. In this way, the grating antenna operates as a silicon waveguide optimized to carry a single transverse electric (TE) mode at the design frequency (e.g., a free-space wavelength of λₒ=1.55 μm). The nanopillars deposited on top are the physical perturbations to couple the guided mode to a free-space emission. The perturbations are periodically arranged, such that they are separated by a distance equal to the guided wavelength. The pairs of nanopillars have asymmetry and rotation, which achieves good efficiency for broadside emissions. To reiterate, the pillars in each pair are rotated the same angle i in opposite directions in order to produce the rotated polarity in the emission.

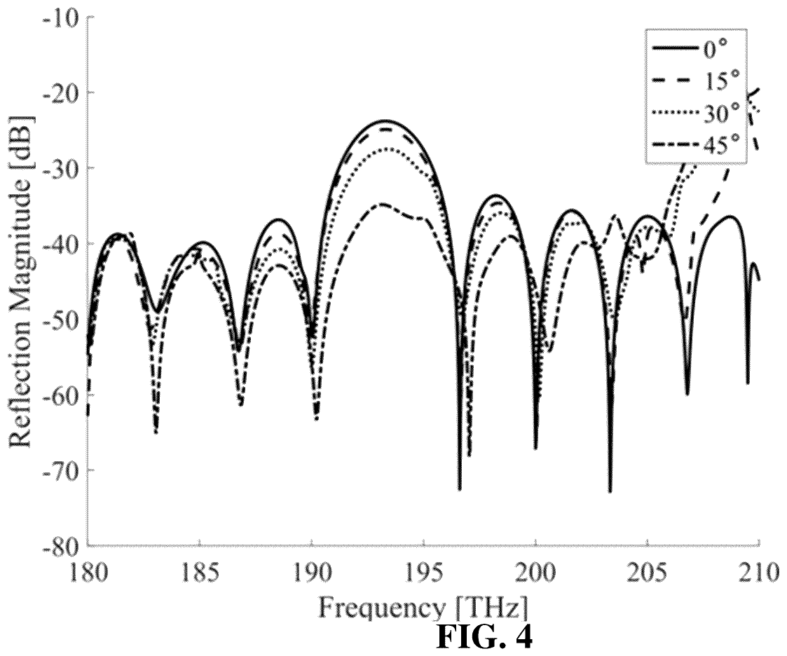

FIGS. 4-8 demonstrate the effect of increasing the pillar displacements, which is to improve matching as the asymmetrical nanopillars approach λ_{g}/4 offset. Plots of the transmission coefficient across the same dimension sweep show that −2 dB of power is coupled to broadside emissions at the design frequency of 194 THz. In general, the leaked power per unit length can be tailored by decreasing the size of the perturbations.

Also shown is the radiation pattern about the y-axis (e.g., orthogonal to the longitudinal axis of the antenna) for two polarities. The co-polarized gain is shown to be approximately 15 dB greater than the cross-polarized gain, indicating good linearity. Further shown are the co-polarized gains across a frequency sweep. It is observed that across beam-steering angles of ±40° the gain is maintained, which indicates that the stopband issue is resolved.

The bandstop problem is illustrated in FIG. 4. This shows how the reflected power changes with frequency (horizontal axis) and in response to a change in the nano-pillar offset. The asymmetry in each pair and their offset are the main factors that improve matching of the antenna, but it is also observed that rotating the pillars improves the matching by reducing reflection at the design frequency of 193.55 THz. More particularly, FIG. 4 shows the reflected magnitude (S11) of the grating antenna versus frequency, for a number of nano-pillar rotation configurations. As the pillars are rotated to 45 degrees, the matching improves by at least 15 db.

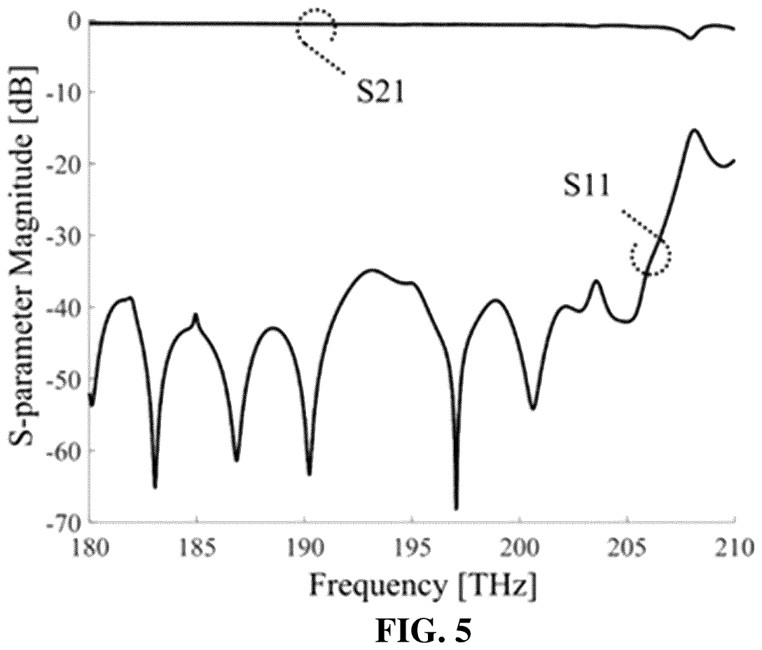

FIG. 5 shows transmission (S21) and reflection magnitudes of the antenna model versus frequency for the optimal antenna geometry, that is, the transmitted and reflected magnitudes versus frequency are plotted in FIG. 5 for an optimal pillar separation condition. The transmission coefficient (S21) shows near unity transmission, whereas, for a sufficiently long antenna, the total input power expected to be radiated from the antenna and S21 would be minimized.

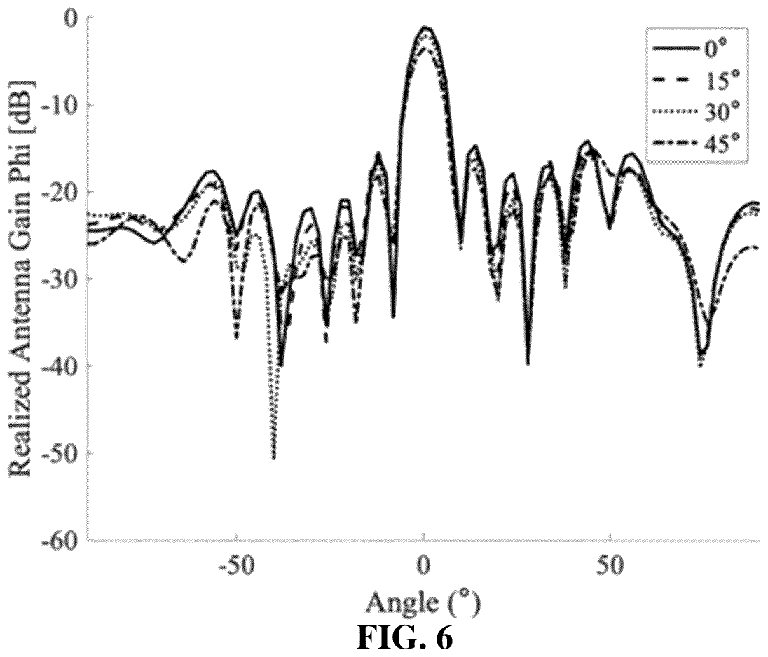

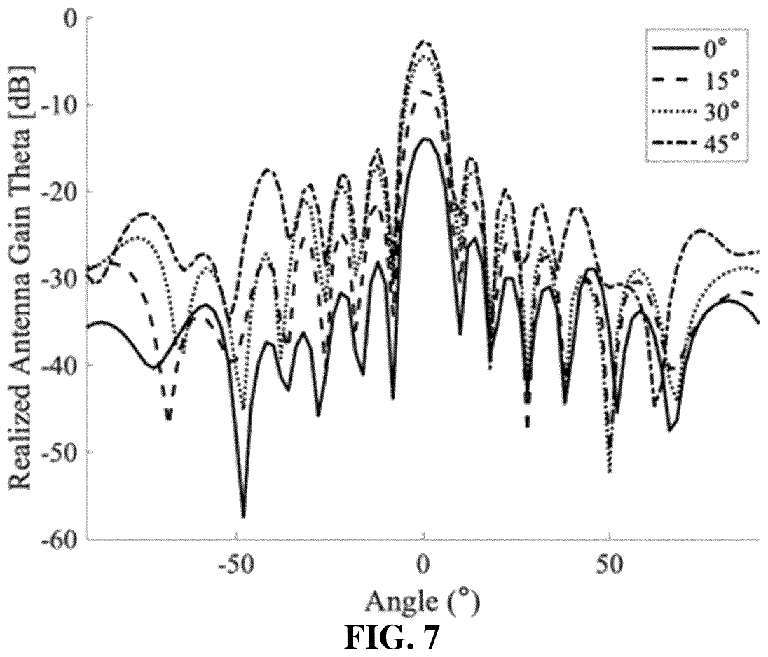

FIGS. 6 and 7 show the gain patterns of the optical antenna across a sweep of frequency. The output gain sees only minor variation (approximately 1.6 dB) across the sweep, indicating that the stopband has been successfully suppressed. More particularly, FIGS. 6 and 7 show gain plots for the travelling wave antenna at 193.55 THz, for the orthogonal (FIG. 6) Phi and (FIG. 7) Theta components. As the pillars are rotated to produce a circular-polarized emission, the components gradually become equal to one another. Gain-phi is ultimately reduced by around 3 dB, whereas gain-theta is increased from a negligible level for the 0-degree condition.

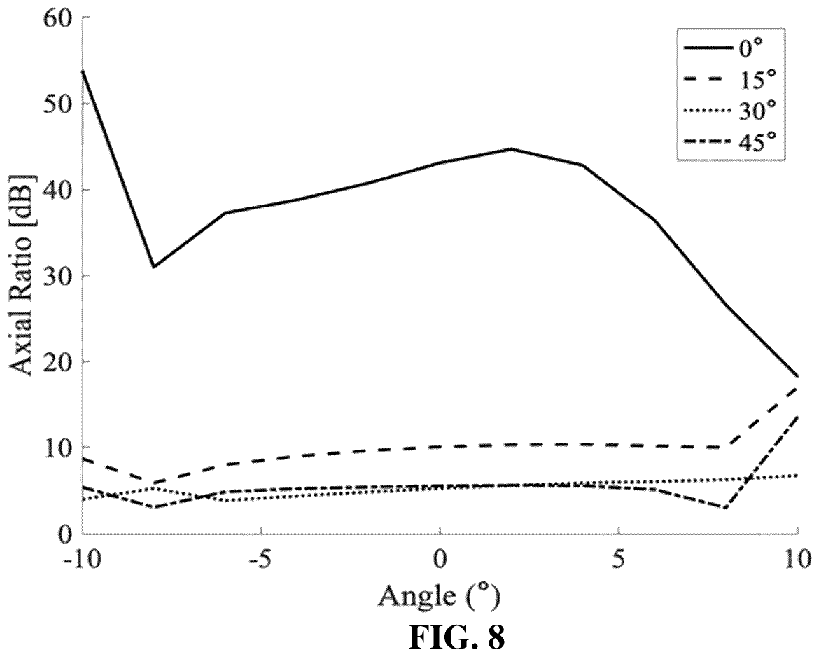

FIG. 8 shows the axial ratio versus beam-angle near broadside at an operating frequency of 193.55 THz, showing trend towards circular polarity (0 dB) as the pillars are rotated fully. For broadside emission by the optimized antenna, as the antenna length is increased, more leakage of power across a large area results in highly directive broadside beam.

While the examples of FIGS. 1-3 and the associated example plots of FIGS. 4-8 have been described based on lateral asymmetry in cuboid nanopillar perturbations to enhance matching for broadside emissions, the technology described herein is not limited to these example designs. Indeed, it is noted that this asymmetrical grating antenna technology can be extended to any kinds of structural perturbations, including plasmonic resonant elements and notches as opposed to the nanopillar perturbations described herein.

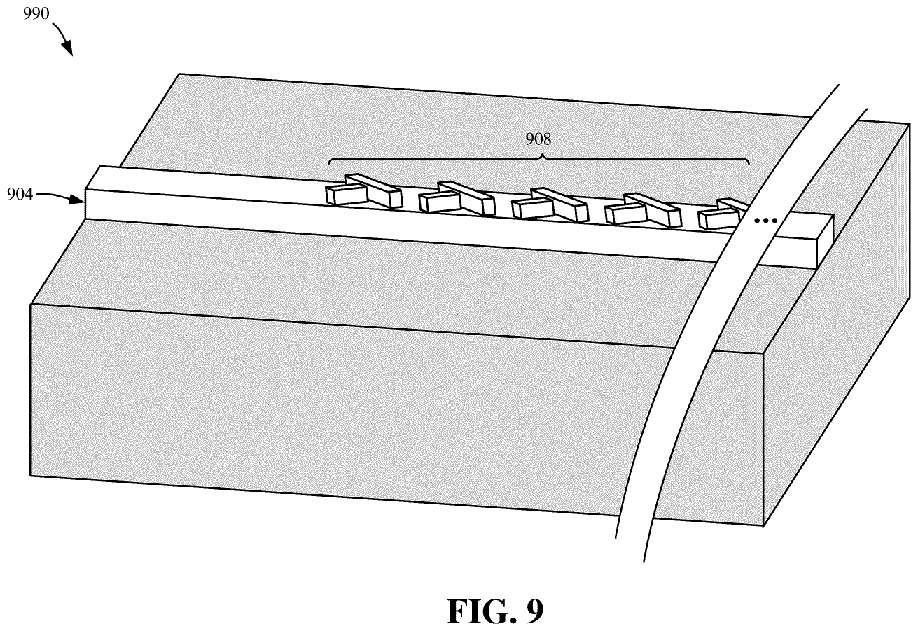

Further, as one design alternative, it is noted that rotation of the perturbations produces rotation of the radiated mode's polarity, as generally represented in the 3D (divided partial) optical travelling-wave antenna structure representation 990 of FIG. 9, showing substantially perpendicularly rotated nanopillars distributed as pairs, oriented substantially diagonally (e.g., as 45°), along the wire waveguide 902.

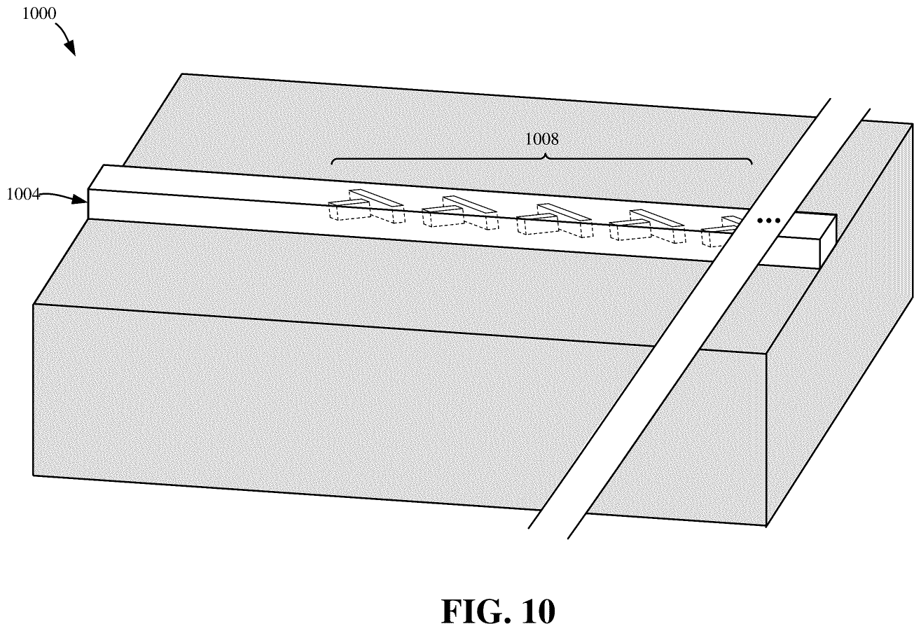

The technology described herein is thus valid for arbitrary perturbation geometries. For example, the optical travelling-wave antenna structure 1000 of FIG. 10 includes a wire 1004 manufactured with asymmetrically arranged perturbations in the form of cuboid (e.g., diagonally-oriented) pairs of substantially perpendicular cavities 1008 (also referred to as trenches or notches), which can provide similar polarized emission results. FIGS. 9 and 10 depict only some nonlimiting examples, and other asymmetrically offset shapes can be used as protrusions or cavities, e.g., ellipsoids/ovoids and so on. Combinations of such designs can be used as well.

One or more implementations can be embodied in a device, such as described in the example embodiments and implementations included herein. The device can include a substrate, and a grating antenna including a waveguide above the substrate. The grating antenna can include a wire having perturbations distributed along a portion of the wire; the perturbations can be configured as respective laterally asymmetrical groups of perturbations, and the respective laterally asymmetrical groups can include respective first perturbations rotated relative to respective second perturbations.

The respective laterally asymmetrical groups of the perturbations can include respective pairs of perturbations that can be fabricated along a length of the wire.

The respective first perturbations can be rotated perpendicularly or substantially perpendicularly relative to the respective second perturbations.

The respective first perturbations can be rotated respective first non-zero angles in a first direction relative to a length of the wire, the respective second perturbations can be rotated respective second non-zero angles in a second direction relative to the length of the wire, and the first direction can be opposite the second direction.

The respective first perturbations can be rotated respective non-zero angular amounts in a first direction relative to the wire, the respective second perturbations can be rotated the respective angular amounts in a second direction relative to the wire, and the first direction can be opposite the second direction.

The respective laterally asymmetrical groups of the perturbations can include respective pairs of nanopillars.

The perturbations can include cuboid-shaped nanopillars.

The perturbations can include cavities.

The cavities can include cuboid-shaped trenches.

The respective laterally asymmetrical groups of the perturbations can be periodically distributed based on a wavelength of an input optical wave.

The respective laterally asymmetrical groups of the perturbations can include respective parallel pairs of perturbations that can be rotated relative to a length of the wire.

The grating antenna can be configured to operate at an optical frequency band.

The substrate can include silicon dioxide, and the wire can include silicon.

One or more implementations can be embodied in an optical travelling-wave antenna, such as described in the example embodiments and implementations included herein. The optical travelling-wave antenna can include a substrate, a wire along a length of the substrate, and respective pairs of perturbations periodically distributed along a portion of a length of the wire. The respective pairs of the perturbations can include respective first perturbations and respective second perturbations, and the respective first perturbations can be rotated relative to the respective second perturbations and relative to the length of the wire.

The respective first perturbations and the respective second perturbations can be rotated in respective opposite directions to produce rotated polarity in an output emission resulting from an optical wave input to the optical travelling-wave antenna.

The first perturbations can be rotated substantially perpendicular relative to the respective second perturbations.

The first perturbations can be rotated substantially diagonally relative to the length of the wire.

The respective pairs of the perturbations can include respective pairs of nanopillars protruding above the wire.

One or more implementations can be embodied in a grating antenna, such as described in the example embodiments and implementations included herein. The grating antenna can include a wire including a length dimension and a width dimension that can be smaller than the length dimension, and respective pairs of nanopillars protruding above a portion of the wire. The respective pairs can be periodically distributed along the portion of the wire in the length dimension, the respective pairs of nanopillars can include respective first nanopillars and respective second nanopillars, and the respective first nanopillars can be rotated relative to the respective second nanopillars to produce rotated polarity in an output emission resulting from an optical wave input to the grating antenna.

The respective pairs of nanopillars can be periodically distributed with respective separation distances that can be based on a wavelength of an input optical wave.

As can be seen, described herein is an optical antenna for circular-polarized emissions, such as for use in the telecommunications infrared band (e.g., 1550 nm or 194 THz) or other applications (e.g., LIDAR and holographic displays). A general design is a traveling wave or leaky wave antenna, which includes a silicon-on-insulator (SOI) waveguide with protrusions in the form of nano-pillars distributed along the top, which serve as perturbations to couple the guided mode to a directed free-space emission. The nano-pillars are arranged in pairs that are staggered/asymmetric, so as to improve matching and mitigate the stopband effect expected for traveling wave antennas operating with broad-side emissions. Circularly-polarized emissions are realized through opposite rotation of the pillars, e.g., to ±45°.

The technology described herein thus facilitates an optical antenna design which demonstrates good efficiency across a range of beam-steering angles for circularly polarized emissions. One implementation of the design addresses this through the incorporation of asymmetrical nanopillars into an SOI wire to couple the guided mode to a propagating leaky wave mode, thereby overcoming a bandstop which is characteristic of travelling wave antennas and normally hinders broadside radiating efficiency. Such an approach to grating coupler design provides the increased flexibility of implementing monolithic lasers and couplers for a silicon photonics circuit. One such grating antenna is constructed from a silicon wire on silicon dioxide substrate here as a conceptual example, and can be designed to operate through the infrared C-band (e.g., 191.6-195.9 THz).

To summarize, described is a grating antenna that leverages asymmetrical nanopillars (or trenches) to achieve high broadside emissions with polarization control ranging from purely linear to elliptical depending on designed angles. This approach overcomes the stopband problem in the optical regime. The antenna is built on an SOI architecture with features that are easily fabricated using conventional monolithic fabrication processes.

Turning to usage scenarios in general, optical antennas are relevant for their applications to displays, sensors, high throughput wireless communications, and as laser sources. Grating couplers are a subset of optical antennas, which are composed of a waveguide with perturbations in the form of pillars or grooves etched into the waveguiding structure. The perturbations permit coupling between the guided mode through the structure (e.g., a fundamental mode for the particular dielectric waveguide implementation) and a free-space or alternative guiding mode (e.g., a fiber-optic cable mode).

Grating antennas are used for coupling optical surface waves to free space or optical fibers. Across the length of the antenna, a guided wave is progressively ‘leaked’ into the coupled mode through perturbations in the guiding structure such as nanopillars or trenches. If the leakage per unit-length is sufficiently small, high directionality for applications, such as LIDAR or optical communications, can be achieved by elongating the radiating structure to be several orders of magnitude greater than the guided wavelength. Furthermore, if a fixed periodicity to the perturbations is assumed, the beam-steering direction of the antenna is dictated by the frequency of operation. An issue with grating antennas, which is well-known by leaky-wave antenna (LWA) designers in the RF domain, is that as the guided wavelength approaches the grating period, matching is reduced due to constructive interference of reflections from the perturbations.

Thus, a silicon-based optical grating coupler can be a dielectric waveguide with periodically arranged perturbations along the length. The perturbations can take the form of nano-pillars or trenches, which are engineered to couple the guided mode through the grating structure to some other mode which can be either the guided mode of another waveguide structure (e.g. a fiber-optic cable which is abutted to the wafer) or a propagating free space mode in which case the structure is operated as a travelling wave antenna. The direction of propagation is dependent on the input wavelength.

A common shortfall of conventional travelling wave antennas, overcome by the technology described herein, is their sharp reduction in matching (e.g., high reflection of the input energy occurs) across a frequency band which produces broad-side emissions (e.g., ninety degrees (90°) to the wafer plane). This reduction in efficiency through this frequency range is known as a stopband problem, and it is well-documented in leaky-wave antennas operating through RF frequency ranges. Indeed, for grating antennas, the direction of the free-space emission is dependent on the frequency/wavelength of operation. If each perturbation (which can be a single or pair of structures of the type mentioned before) can be considered as a point source, then the phase offset of successive elements are a function of the guided wavelength and the perturbation period. For the broadside emission case where the main radiation pattern lobe is oriented 90° with respect to a wafer plane, the phase offset of successive elements is equal to 2π. Given the sinusoidal nature of the guided wave, this sets the perturbation period to be about λ_{g}. Due to the interference pattern of the guided mode in response to this configuration, the matching reduces in a phenomenon which is well documented (in radio frequency literature) as the ‘bandstop problem.’

As described herein, the bandstop problem can be overcome by implementing the perturbation as a pair of features that have asymmetric geometry. The pair of perturbations can be a pair of pillars on top of the waveguide, which are separated such that the reflections from the two destructively interfere to improve matching (e.g., a separation of about λ_{g}/4 at the frequency producing broad-side emissions). Rotation of the perturbations, which results in circularly polarized broadside emissions, further improves the matching by reducing reflection.

The technology described herein, which in one implementation shows an antenna design, provides a solution to the bandstop problem in optical antennas. By introducing rotation to the pillars, the guided mode can be coupled to a free-space emission which has tunable polarization. In particular, it is of interest to produce circularly polarized emissions, given their applicability to the detection of chiral specimens and their integration with Pancharatnam-Berry phase lenses which can refract circularly polarized waves.

This bandstop issue can be overcome by introducing lateral or longitudinal asymmetry in the perturbation geometry. For example, by designing pairs of perturbations at λ_{g}/4 intervals, the reflections instead destructively interfere to improve matching for broadside emissions.

Through nanofabrication techniques, these antennas can be realized as a silicon-on-insulator (SOI) device. By clustering multiple antennas into an array with independently tuned phase, amplitude, and directivity it is proposed that a reconfigurable, holographic display could be produced.

The technology described herein includes variants of the grating antenna, each of which overcome the broadside, bandstop issue through an incorporation of asymmetrical perturbations. The variants described herein tailor the emissions based on directivity and polarity and demonstrate the validity of the approach to maximizing broadside gain in an optical grating antenna. The designs are demonstrated in simulation and have dimensions that can be fabricated through e-beam lithography (EBL).

Thus, described herein is lateral asymmetry in the perturbations enhance matching for broadside emissions. Rotation of the perturbations produces (and is shown to produce) rotation of the radiated mode's polarity. The technology described herein is valid for arbitrary perturbation geometries. For example, asymmetrically arranged cylindrical, or rectangular notches are valid.

Grating couplers have been widely applied to couple energy to and from photonic circuits. The current approaches to grating couplers have used apodization in their perturbations, in order to efficiently couple between silicon and a different class of waveguide (e.g., fiber optic cable). High directivity grating antennas have been applied to LIDAR sources. Examples of these approaches have either assumed off-broadside emission, or have not explored the variation in antenna efficiency versus frequency of operation. Grating antennas have been codesigned with photonic crystal structures to mitigate symmetrical emissions (e.g., in symmetrical directions on either side of the wafer plane). Polarization control of emissions through perturbation rotation have received much attention in the RF domain for mm-wave leaky wave antennas, but not for optical frequencies.

Usage examples of the technology described herein include, but are not limited to, a LIDAR Source; the grating coupler can be implemented as a high-directivity laser source for LIDAR applications, for which a device containing an array of these antennas can be used to detect and range-find along directions paraxial to the wafer normal vector. Such a device benefits from high efficiency across a large frequency range and beam-steering angles.

Another usage example is with respect to sensors and monitoring, as chemicals and substances have characteristic absorption spectra through the infrared frequency range that is dependent on the chirality in the structure of their molecules, and therefore can be detected and monitored through detection of transmitted light from a source. For this purpose, the design described herein can be applied as a source, because the output power is universally high across the operating frequency range with the advent of bandstop suppression.

Infrared wireless communications are facilitated, as optical wireless links benefit from high throughput, low latency, and high capacity. A device based on this antenna design described herein can be used to establish wireless links that are dynamic, being steered in real time to address different targets in an environment. Furthermore, these antennas can be used in conjunction with RF-domain antennas, given their size and integrability.

The general strategy of maximizing efficiency for broadside emissions can be integrated into more conventional grating couplers, which are widespread for prototyping of photonic circuits in research and industry.

Holographic displays are another usage example; such a grating antenna structure can be configured into pixels in a display. Through frequency-dependent beam-steering, the pixels can function in an array as a reconfigurable holographic display.

What has been described above include mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
a substrate; and
a grating antenna comprising a waveguide above the substrate, the grating antenna comprising a wire having perturbations distributed along a portion of the wire, wherein the perturbations are configured as respective laterally asymmetrical groups of perturbations, and wherein the respective laterally asymmetrical groups comprise respective first perturbations rotated relative to respective second perturbations.

2. The device of claim 1, wherein the respective laterally asymmetrical groups of the perturbations comprise respective pairs of perturbations that are fabricated along a length of the wire.

3. The device of claim 1, wherein the respective first perturbations are rotated perpendicularly or substantially perpendicularly relative to the respective second perturbations.

4. The device of claim 1, wherein the respective first perturbations are rotated respective first non-zero angles in a first direction relative to a length of the wire, wherein the respective second perturbations are rotated respective second non-zero angles in a second direction relative to the length of the wire, and wherein the first direction is opposite the second direction.

5. The device of claim 1, wherein the respective first perturbations are rotated respective non-zero angular amounts in a first direction relative to the wire, wherein the respective second perturbations are rotated the respective angular amounts in a second direction relative to the wire, and wherein the first direction is opposite the second direction.

6. The device of claim 1, wherein the respective laterally asymmetrical groups of the perturbations comprise respective pairs of nanopillars.

7. The device of claim 6, wherein the perturbations comprise cuboid-shaped nanopillars.

8. The device of claim 1, wherein the perturbations comprise cavities.

9. The device of claim 8, wherein the cavities comprise cuboid-shaped trenches.

10. The device of claim 1, wherein the respective laterally asymmetrical groups of the perturbations are periodically distributed based on a wavelength of an input optical wave.

11. The device of claim 1, wherein the respective laterally asymmetrical groups of the perturbations comprise respective parallel pairs of perturbations that are rotated relative to a length of the wire.

12. The device of claim 1, wherein the grating antenna is configured to operate at an optical frequency band.

13. The device of claim 1, wherein the substrate comprises silicon dioxide, and wherein the wire comprises silicon.

14. An optical travelling-wave antenna, comprising:
a substrate;
a wire along a length of the substrate; and
respective pairs of perturbations periodically distributed along a portion of a length of the wire, the respective pairs of the perturbations comprising respective first perturbations and respective second perturbations, wherein the respective first perturbations are rotated relative to the respective second perturbations and relative to the length of the wire.

15. The optical travelling-wave antenna of claim 14, wherein the respective first perturbations and the respective second perturbations are rotated in respective opposite directions to produce rotated polarity in an output emission resulting from an optical wave input to the optical travelling-wave antenna.

16. The optical travelling-wave antenna of claim 14, wherein the first perturbations are rotated substantially perpendicular relative to the respective second perturbations.

17. The optical travelling-wave antenna of claim 14, wherein the first perturbations are rotated substantially diagonally relative to the length of the wire.

18. The optical travelling-wave antenna of claim 14, wherein the respective pairs of the perturbations comprise respective pairs of nanopillars protruding above the wire.

19. A grating antenna, comprising:
a wire comprising a length dimension and a width dimension that is smaller than the length dimension; and
respective pairs of nanopillars protruding above a portion of the wire, the respective pairs periodically distributed along the portion of the wire in the length dimension, wherein the respective pairs of nanopillars comprise respective first nanopillars and respective second nanopillars, and wherein the respective first nanopillars are rotated relative to the respective second nanopillars to produce rotated polarity in an output emission resulting from an optical wave input to the grating antenna.

20. The grating antenna of claim 19, wherein the respective pairs of nanopillars are periodically distributed with respective separation distances that are based on a wavelength of an input optical wave.
